(19) United States
(12) Patent Application Publication
(10) Pub. No.: US 2011/0262851 A1
(43) Pub. Date: Oct. 27, 2011

(54) ELECTROHPHOTOGRAPHIC TONER

(75) Inventors: Taishi Takano, Shizuoka-ken (JP); Takashi Urabe, Shizuoka-ken (JP)

(73) Assignee: TOSHIBA TEC KABUSHIKI KAISHA, Tokyo (JP)

(21) Appl. No.: 13/093,169

(22) Filed: Apr. 25, 2011

Related U.S. Application Data
(60) Provisional application No. 61/327,870, filed on Apr. 26, 2010.

(51) Int. Cl. G03G 9/08

(52) U.S. Cl. 430/105; 430/137.14

(57) ABSTRACT

Disclosed is an electrophotographic toner containing a binder resin, a coloring agent, and a release agent, having a volume average particle diameter of 7 μm or less, and having an acid value per unit surface area SAV (mgKOH/m²) of 0.05 or more but not exceeding 0.2.

### CROSS-REFERENCE TO RELATED APPLICATION

This application is also based upon and claims the benefit of priority from U.S. provisional application 61/327870, filed on Apr. 26, 2010; the entire contents of which are incorporated herein by reference.

### FIELD

Embodiments described herein relate to a technique of an electrophotographic toner.

### BACKGROUND

In order not to cause image defects such as fogging, it is very important that a toner has a stable charging property even under different environmental conditions.

It is proposed that when the charging property of a toner is designed, controlling of the total acid value or surface acid value of a resin is effective. However, the surface area of a toner is increased as the particle diameter thereof is decreased, and therefore, the surface acid value is increased accompanied thereby. Further, particularly in the case of a toner produced through a step of aggregating and fusing fine particles, the surface conditions are significantly changed in some cases by controlling the surface shape of the toner, and the surface acid value is also largely affected.

That is, it was not easy to form a toner having a stable charging property by controlling the total acid value or surface acid value when the particle diameter of the toner was small.

### DESCRIPTION OF THE DRAWINGS

FIG. 1 is a table showing the properties of toners of Examples and Comparative examples.

FIG. 2 is a graph showing a relationship between an acid value per unit surface area SAV (mgKOH/m²) and an environmental coefficient of variation (%).

### DETAILED DESCRIPTION

The toner according to an embodiment contains a binder resin, a coloring agent, and a release agent, has a volume average particle diameter of 7 μm or less, and has an acid value per unit surface area SAV (mgKOH/m²) of 0.05 or more but not exceeding 0.2.

Hereinafter embodiments will be described with reference to the drawings.

As the particle diameter of a toner is decreased, it becomes not easy to obtain a stable charging property by controlling the total acid value or surface acid value. In particular, in the case of a toner having a volume average particle diameter of 7 μm or less, the specific surface area thereof is rapidly increased due to a decrease in the particle diameter, and therefore, it becomes further not easy to obtain a stable charging property.

As a result of intensive studies, the present inventors found that by setting the acid value per unit surface area SAV (mgKOH/m²) to 0.05 or more but not exceeding 0.2 in a toner having a volume average particle diameter of 7 μm or less, a change between the charge amount of the toner under a low-temperature and low-humidity environment and the charge amount thereof under a high-temperature and high-humidity environment can be suppressed low, and thus completed the embodiments described herein.

The acid value SAV is more preferably 0.09 or more but not exceeding 0.16.

If the acid value SAV is less than 0.05, the BET specific surface area of a toner is considered to be extremely high, and in such a case, the toner particles are not sufficiently fused. Meanwhile, if the acid value SAV is more than 0.2, the acid value of a material itself which is used for the toner particles is high, and the toner is easily charged under a low-temperature and low-humidity environment, but cannot be sufficiently charged under a high-temperature and high-humidity environment because the amount of water adsorbed thereto is large.

The acid value per unit surface area SAV of a toner can be calculated based on the following formula.

SAV=m/n

In the formula, SAV represents the acid value per unit surface area of the toner (mgKOH/m²); m represents the surface acid value of the toner (mgKOH/g); and n represents the BET specific surface area of the toner (m²/g)

Further, the surface acid value and the BET specific surface area of a toner can be measured by the following methods.

The measurement of the BET specific surface area of a toner can be performed according to JIS Z8830. As a measurement device, for example, an automatic specific surface area and pore distribution analyzer TriStar 3000 (manufactured by Shimadzu Corporation) is used. In the measurement, 1.0 g of a toner sample is sufficiently degassed under vacuum at 20° C. over 4 hours, and the BET specific surface area is measured using N₂ gas as an adsorption gas.

Meanwhile, the measurement of the surface acid value of a toner can be performed as follows, for example. First, to a 200-ml beaker, 10 ml of an aqueous solution of 10 wt % Noigen XL-140 and 5.0 g of a toner are added, and the resulting mixture is diluted with 85 ml of pure water and stirred using a stirrer for 1 minute. Then, a dispersion treatment is performed for 10 minutes using an ultrasonic disperser, whereby a toner dispersion liquid is prepared. Then, the measurement is performed by a potentiometric titration method as described in JIS K0070 using an aqueous solution of 0.01 mol/1 potassium hydroxide to obtain the amount of the aqueous solution of 0.01 mol/1 potassium hydroxide required for neutralization. Then, a difference between the amount of the aqueous solution of 0.01 mol/1 potassium hydroxide required for neutralization of the toner dispersion liquid and the amount of the aqueous solution of 0.01 mol/1 potassium hydroxide required for neutralization titration of an aqueous solution which contains only a dispersant and does not contain the toner is determined, and the amount of potassium hydroxide required for neutralizing the surface of the entire toner in the aqueous solution is calculated. Then, the amount of potassium hydroxide required for neutralizing 1 g of the toner is calculated from the above calculated amount of potassium hydroxide, whereby the surface acid value of the toner can be obtained.

Further, in this embodiment, the volume average particle diameter of the toner is 7 μm or less. The “volume average particle diameter” as used herein refers to the particle diameter of a particle the value of which is arrived at when the cumulative volume distribution of the particles reaches 50% determined from the sum of the volumes of the individual particles calculated from the particle diameters (volume D50) The volume average particle diameter can be determined using, for example, Multisizer 3 (manufactured by Beckman Coulter, Inc., aperture diameter: 100 μm). The volume average particle diameter can be obtained by measuring the particle diameters of, for example, 50000 particles. Incidentally, the lower limit of the volume average particle diameter of the toner is not particularly limited, however, in consideration of scattering or the like when handling, the lower limit can be set to 3 μm or more.

Subsequently, components contained in the toner according to this embodiment will be described.

The toner according to this embodiment contains at least a binder resin, a coloring agent, and a release agent.

Examples of the binder resin according to this embodiment include polyester, styrene acrylate, polyurethane, and an epoxy resin, and particularly, a polyester resin having a glass transition temperature Tg of 60° C. or lower is preferred from the viewpoint of low-temperature fixability. As the polyester, for example, as raw material monomers of the polyester, a dihydric or higher hydric alcohol component and a divalent or higher valent carboxylic acid component such as carboxylic acid, carboxylic anhydride, or carboxylic acid ester are used. As the styrene acrylate, a styrene polymer, a styrene-diene copolymer, a styrene-alkyl (meth)acrylate copolymer, and the like can be exemplified.

The molecular weight of the binder resin is not particularly limited, and can be suitably determined by a person skilled in the art. However, from the viewpoint of low-temperature fixability, for example, the weight average molecular weight Mw of the polyester resin can be set to 5000 or more and 50000 or less. Further, the melting point thereof is preferably from 80 to 130° C., and also the glass transition temperature Tg thereof is preferably from 30 to 60° C.

As the coloring agent according to this embodiment, a carbon black, an organic or inorganic pigment or dye, or the like is used.

Examples of the carbon black include acetylene black, furnace black, thermal black, channel black, and Ketjen black. Examples of the pigment and dye include fast yellow G, benzidine Yellow, indofast orange, irgajin red, carmen FB, permanent bordeaux FRR, pigment orange R, lithol red 2G, lake red C, rhodamine FB, rhodamine B lake, phthalocyanine blue, pigment blue, brilliant green B, phthalocyanine green, and quinacridone. These coloring agents can be used alone or in admixture.

Examples of the release agent according to this embodiment include waxes. Examples of the waxes include aliphatic hydrocarbon waxes such as low-molecular weight polyethylenes, low-molecular weight polypropylenes, polyolefin copolymers, polyolefin waxes, microcrystalline waxes, paraffin waxes, and Fischer-Tropsch waxes; oxides of an aliphatic hydrocarbon wax such as polyethylene oxide waxes or block copolymers thereof; vegetable waxes such as candelilla wax, carnauba wax, Japan wax, jojoba wax, and rice wax; animal waxes such as beeswax, lanolin, and spermaceti wax; mineral waxes such as ozokerite, ceresin, and petrolactum; waxes containing, as a main component, a fatty acid ester such as montanic acid ester wax and castor wax; and deoxidation products resulting from deoxidation of a part or the whole of a fatty acid ester such as deoxidized carnauba wax.

Further, in the toner according to this embodiment, a component other than the binder resin, the coloring agent, and the release agent may be contained, and for example, a charge control agent may be contained. As the charge control agent, a metal-containing azo compound is used, and the metal element is preferably a complex or a complex salt of iron, cobalt, or chromium or a mixture thereof. Further, a metal-containing salicylic acid derivative compound is also used, and the metal element is preferably a complex or a complex salt of zirconium, zinc, chromium, or boron, or a mixture thereof. Further, in order to adjust the fluidity or chargeability of toner particles, inorganic fine particles may be externally added and mixed therewith. As such inorganic fine particles, silica, titania, alumina, strontium titanate, tin oxide, and the like can be used alone or in admixture of two or more kinds thereof. It is preferred that as the inorganic fine particles, those surface-treated with a hydrophobizing agent are used from the viewpoint of improvement of environmental stability. Further, other than such inorganic oxides, resin fine particles having a size of 1 μm or less can be added for improving the cleaning property.

Still further, when the toner according to this embodiment is produced, an aggregating agent, a surfactant or the like can be used.

Examples of the aggregating agent include metal salts such as sodium chloride, calcium chloride, calcium nitrate, barium chloride, magnesium chloride, zinc chloride, magnesium sulfate, aluminum chloride, aluminum sulfate, and potassium aluminum sulfate; inorganic metal salt polymers such as polyaluminum chloride, polyaluminum hydroxide, and calcium polysulfide; polymeric aggregating agents such as polymethacrylic acid esters, polyacrylic acid esters, polyacrylamides, and acrylamide-sodium acrylate copolymers; coagulating agents such as polyamines, polydiallyl ammonium halides, melanin formaldehyde condensates, and dicyandiamide; alcohols such as methanol, ethanol, 1-propanol, 2-propanol, 2-methyl-2-propanol, 2-methoxyethanol, 2-ethoxyethanol, and 2-butoxyethanol; organic solvents such as acetonitrile and 1,4-dioxane; inorganic acids such as hydrochloric acid and nitric acid; and organic acids such as formic acid and acetic acid.

Examples of the surfactant include anionic surfactants such as sulfate-based, sulfonate-based, phosphate-based, and soap-based anionic surfactants; cationic surfactants such as amine salt-based, and quaternary ammonium salt-based cationic surfactants; and nonionic surfactants such as polyethylene glycol-based, alkyl phenol ethylene oxide adduct-based, and polyhydric alcohol-based nonionic surfactants.

A method for producing the toner according to this embodiment is not particularly limited, however, for example, the toner can be produced by aggregating and fusing a binder resin, a coloring agent, and a release agent in an aqueous medium containing water, an organic solvent which is miscible with water, and the like.

Specifically, for example, the toner can be produced as described below.

First, constituent components (a binder resin, a coloring agent, and a release agent) are kneaded using a twin-screw kneader, and the resulting kneaded material is pulverized, whereby a coarsely pulverized composition is obtained.

To this coarsely pulverized composition, an aqueous medium containing a surfactant, water, an organic solvent which is miscible with water, and the like is added, whereby a toner material dispersion liquid is prepared. This toner material dispersion liquid is subjected to a high-pressure homogenizer or the like to effect pulverization. Subsequently, the toner material dispersion liquid in which the components were pulverized is subjected to an aggregation and fusion step. Specifically, an aggregating agent is added to the toner material dispersion liquid, followed by heating to aggregate the pulverized components. The type of the aggregating agent, the addition amount thereof, and the heating temperature can be suitably determined by a person skilled in the art.

Thereafter, the fluidity of the binder resin is increased by heating, whereby the aggregated binder resin, coloring agent, and release agent are fused to one another. The heating temperature in the fusion treatment can also be suitably determined by a person skilled in the art.

The acid value per unit surface area SAV of the toner can be adjusted according to the type or amount of the aggregating agent, temperature in the aggregation or fusion treatment, or the like.

For example, as the aggregating agent, hydrochloric acid, sulfuric acid, nitric acid, phosphoric acid, acetic acid, acetic anhydride, citric acid, a mixture of at least two or more compounds selected therefrom, or the like is used. Then, the aggregation temperature (specifically, the temperature of the aqueous medium during the aggregation treatment) is set to 20° C. or higher but not exceeding the glass transition temperature of the resin, and the fusion temperature (specifically, the temperature of the aqueous medium during the fusion treatment) is set to the glass transition temperature of the resin or higher but not exceeding 100° C. Further, if the fusion temperature is higher than the aggregation temperature, the condition for raising the temperature of the aqueous medium after the aggregation treatment is set such that the initial temperature is set to 20° C. or higher but not exceeding the glass transition temperature of the resin (for example 30° C.) and the temperature is raised at a rate of 0.33° C./min (10° C./30 min)

Subsequently, particles obtained by the fusion treatment are washed and dried, whereby a toner is produced. To the thus produced toner, an external additive such as silica or titanium oxide is externally added as needed.

The toner according to this embodiment can be used as, for example, a non-magnetic one-component developer or two-component developer in the formation of an image employing an electrophotographic system or the like. When the toner is used in a two-component developer, a carrier which can be used is not particularly limited and can be suitably determined by a person skilled in the art.

### EXAMPLES

Subsequently, the toner according to this embodiment will be described with reference to examples. However, the invention is not limited to the following examples.

Incidentally, the environmental coefficient of variation of each of the toners of Examples and Comparative examples was determined as follows.

First, 6.5 g of a toner and 93.5 g of a carrier were weighed in 100-cc polyethylene bottles, and the bottles were left as such for 8 hours or more under a high-temperature and high-humidity environment or a low-temperature and low-humidity environment. Then, stirring was performed for 30 minutes using a Turbula mixer under the respective environment, and the charge amount (Q/M) was measured. From the obtained value of the charge amount, the environmental coefficient of variation (%) was determined based on the following formula.

EC=(HT/LT)×100

In the formula, EC represents an environmental coefficient of variation (%); HT represents a charge amount under a high-temperature and high-humidity environment; and LT represents a charge amount under a low-temperature and low-humidity environment.

In the high-temperature and high-humidity environment, the temperature was set to 30° C. and the relative humidity was set to 85%, and in the low-temperature and low-humidity environment, the temperature was set to 10° C. and the relative humidity was set to 20%. In general, when the charge amount of a developer is 60 μC/g or more, it becomes not easy to effect development and a sufficient image density cannot be obtained, and when the charge amount of a developer is 15 μC/g or less, image fogging, smearing on the back side of paper, tonner scattering in the apparatus, or the like occurs, although it depends on the structure or the like of the apparatus. The absolute value of such a charge amount can be adjusted by a treatment such as external addition, however, the environmental coefficient of variation itself depends on the property of the toner base body.

Therefore, in order to obtain a favorable charging property, the environmental coefficient of variation is preferably at least 25% or more.

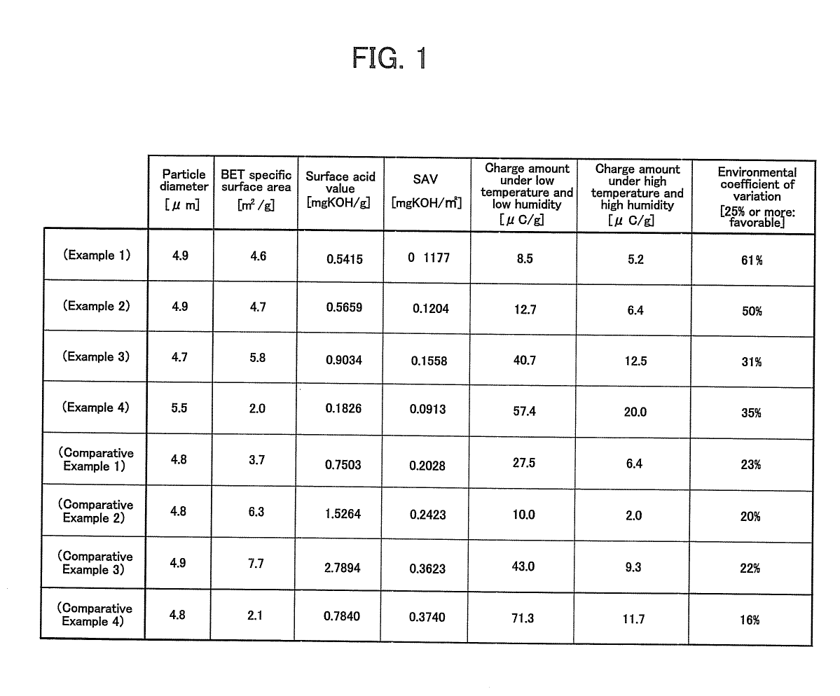

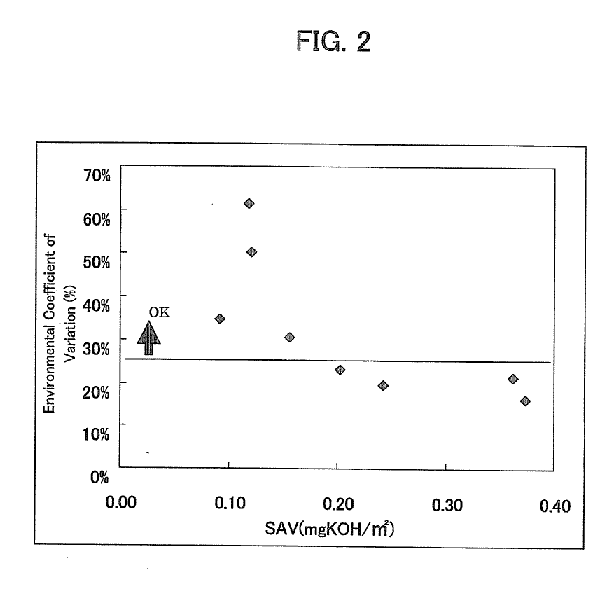

Hereinafter, processes for producing toners of Examples and Comparative examples will be specifically described. Further, the properties of the respective toners are shown in FIG. 1, and a relationship between an acid value per unit surface area SAV (mgKOH/m²) and an environmental coefficient of variation (%) is shown in FIG. 2.

Production of Toner Material Fine Particle Dispersion Liquid 1

90 parts by mass, in terms of a solid content, of a polyester resin, 5 parts by mass of carnauba wax as a release agent, and 5 parts by mass of a cyan pigment were kneaded in a twin-screw kneader, and the resulting kneaded material was pulverized, whereby a coarsely pulverized composition was obtained.

To 100 parts by mass of this coarsely pulverized material of a toner, 1.0 part by mass of an anionic surfactant, Neogen R (manufactured by Dai-ichi Kogyo Seiyaku Co., Ltd.) as a surfactant, 2.1 parts by mass of dimethylaminoethanol (DMAE), and 330 parts by mass of deionized water were added, whereby a toner material dispersion liquid was prepared. This toner material dispersion liquid was subjected to a high-pressure homogenizer to effect pulverization under a condition at 160° C. and 150 MPa. Then, the resulting material was cooled to normal temperature, whereby toner material fine particle dispersion liquid 1 was produced. The volume average particle diameter of particles contained in the dispersion liquid 1 was measured by a laser diffraction particle size distribution analyzer (SALD-7000, manufactured by Shimadzu Corporation), and found to be 0.52 μm.

### Example 1

100 parts by mass of the dispersion liquid 1 (solid content concentration: 40%) and 100 parts by mass of deionized water were placed in a glass-made separable flask equipped with a stirrer. As an aggregating agent, an aqueous solution of hydrochloric acid was continuously added dropwise thereto using a pump while rotating a paddle-type stirring blade at 700 rpm and keeping the internal temperature of the flask at 30° C. Hydrochloric acid was added in an amount of 0.30 parts by mass based on the toner solid content. Subsequently, the temperature was raised to 85° C. over 3 hours, and then 600 parts by mass of deionized water was continuously added dropwise thereto and the temperature was kept at 85° C. for 1 hour, thereby fusing the toner particles. After cooling, the obtained toner particles were washed using a filtration device until the electrical conductivity of the washing water became 0.5 μS/cm, and then dried using a vacuum dryer until the water content became 0.3 wt %. The thus obtained toner particles had a volume average particle diameter of 4.9 μm and a CV value representing the distribution of 20%. The measurement was performed using Multisizer 3 (manufactured by Beckman Coulter, Inc., aperture diameter: 100 μm). The same shall apply to the other Examples and Comparative examples. Further, the resulting toner had a BET specific surface area of 4.6 m²/g, a surface acid value of 0.5415 mgKOH/g, and an SAV of 0.1177 mgKOH/m². The charge amount under low temperature and low humidity was 8.5 μC/g, the charge amount under high temperature and high humidity was 5.2 μC/g, and the environmental coefficient of variation was 61%, which was favorable.

### Example 2

100 parts by mass of the dispersion liquid 1 (solid content concentration: 40%) and 100 parts by mass of deionized water were placed in a glass-made separable flask equipped with a stirrer. As an aggregating agent, an aqueous solution of hydrochloric acid was continuously added dropwise thereto using a pump while rotating a paddle-type stirring blade at 700 rpm and keeping the internal temperature of the flask at 30° C. Hydrochloric acid was added in an amount of 0.30 parts by mass based on the toner solid content. Subsequently, the temperature was raised to 85° C. over 3 hours, and then 400 parts by mass of deionized water was continuously added dropwise thereto and the temperature was kept at 85° C. for 1 hour, thereby fusing the toner particles. After cooling, the obtained toner particles were washed using a filtration device until the electrical conductivity of the washing water became 0.5 μS/cm, and then dried using a vacuum dryer until the water content became 0.3 wt %. The thus obtained toner particles had a volume average particle diameter of 4.9 μm and a CV value representing the distribution of 22%. Further, the resulting toner had a BET specific surface area of 4.7 m²/g, a surface acid value of 0.5659 mgKOH/g, and an SAV of 0.1204 mgKOH/m². The charge amount under low temperature and low humidity was 12.7 μC/g, the charge amount under high temperature and high humidity was 6.4 μC/g, and the environmental coefficient of variation was 50%, which was favorable.

### Example 3

100 parts by mass of the dispersion liquid 1 (solid content concentration: 40%) and 100 parts by mass of deionized water were placed in a glass-made separable flask equipped with a stirrer. As an aggregating agent, an aqueous solution of hydrochloric acid was continuously added dropwise thereto using a pump while rotating a paddle-type stirring blade at 700 rpm and keeping the internal temperature of the flask at 30° C. Hydrochloric acid was added in an amount of 0.30 parts by mass based on the toner solid content. Subsequently, the temperature was raised to 85° C. over 1.5 hours, and then 200 parts by mass of deionized water was continuously added dropwise thereto and the temperature was kept at 85° C. for 2 hours, thereby fusing the toner particles. After cooling, the obtained toner particles were washed using a filtration device until the electrical conductivity of the washing water became 0.5 μS/cm, and then dried using a vacuum dryer until the water content became 0.3 wt %. The thus obtained toner particles had a volume average particle diameter of 4.7 μm and a CV value representing the distribution of 19%. Further, the resulting toner had a BET specific surface area of 5.8 m²/g, a surface acid value of 0.9034 mgKOH/g, and an SAV of 0.1558 mgKOH/m². The charge amount under low temperature and low humidity was 40.7 μC/g, the charge amount under high temperature and high humidity was 12.5μC/g, and the environmental coefficient of variation was 31%, which was favorable.

### Example 4

The coarsely pulverized composition obtained when preparing the dispersion liquid 1 was subjected to a pulverizing and classifying machine, whereby toner particles having a volume average particle diameter of 5.5 μm and a CV value representing the distribution of 23% were obtained. The resulting toner had a BET specific surface area of 2.0 m²/g, a surface acid value of 0.1826 mgKOH/g, and an SAV of 0.0913 mgKOH/m². The charge amount under low temperature and low humidity was 57.4 μC/g, the charge amount under high temperature and high humidity was 20.0 μC/g, and the environmental coefficient of variation was 35%, which was favorable.

### Comparative Example 1

100 parts by mass of the dispersion liquid 1 (solid content concentration: 40%) and 100 parts by mass of deionized water were placed in a glass-made separable flask equipped with a stirrer. As an aggregating agent, an aqueous solution of hydrochloric acid was continuously added dropwise thereto using a pump while rotating a paddle-type stirring blade at 700 rpm and keeping the internal temperature of the flask at 30° C. Hydrochloric acid was added in an amount of 0.30 parts by mass based on the toner solid content. Subsequently, the temperature was raised to 85° C. over 3 hours, and then 100 parts by mass of deionized water was continuously added dropwise thereto and the temperature was kept at 85° C. for 3 hours, thereby fusing the toner particles. After cooling, the obtained toner particles were washed using a filtration device until the electrical conductivity of the washing water became 0.5 μS/cm, and then dried using a vacuum dryer until the water content became 0.3 wt %. The thus obtained toner particles had a volume average particle diameter of 4.8 μm and a CV value representing the distribution of 18%. Further, the resulting toner had a BET specific surface area of 3.7 m²/g, a surface acid value of 0.7503 mgKOH/g, and an SAV of 0.2028 mgKOH/m². The charge amount under low temperature and low humidity was 27.5 μC/g, the charge amount under high temperature and high humidity was 6.4 μC/g, and the environmental coefficient of variation was 23%.

### Comparative Example 2

100 parts by mass of the dispersion liquid 1 (solid content concentration: 40%) and 100 parts by mass of deionized water were placed in a glass-made separable flask equipped with a stirrer. As an aggregating agent, an aqueous solution of hydrochloric acid was continuously added dropwise thereto using a pump while rotating a paddle-type stirring blade at 700 rpm and keeping the internal temperature of the flask at 30° C. Hydrochloric acid was added in an amount of 0.30 parts by mass based on the toner solid content. Subsequently, the temperature was raised to 85° C. over 3 hours, and then 200 parts by mass of deionized water was continuously added dropwise thereto and the temperature was kept at 85° C. for 1 hour, thereby fusing the toner particles. After cooling, the obtained toner particles were washed using a filtration device until the electrical conductivity of the washing water became 0.5 μS/cm, and then dried using a vacuum dryer until the water content became 0.3 wt %. The thus obtained toner particles had a volume average particle diameter of 4.8 μm and a CV value representing the distribution of 20%. Further, the resulting toner had a BET specific surface area of 6.3 m²/g, a surface acid value of 1.5264 mgKOH/g, and an SAV of 0.2423 mgKOH/m². The charge amount under low temperature and low humidity was 10.0 μC/g, the charge amount under high temperature and high humidity was 2.0μC/g, and the environmental coefficient of variation was 20%.

### Comparative Example 3

100 parts by mass of the dispersion liquid 1 (solid content concentration: 40%) and 100 parts by mass of deionized water were placed in a glass-made separable flask equipped with a stirrer. As an aggregating agent, an aqueous solution of hydrochloric acid was continuously added dropwise thereto using a pump while rotating a paddle-type stirring blade at 700 rpm and keeping the internal temperature of the flask at 30° C. Hydrochloric acid was added in an amount of 0.30 parts by mass based on the toner solid content. Subsequently, the temperature was raised to 85° C. over 3 hours, and then kept at 85° C. for 1 hour, thereby fusing the toner particles. After cooling, the obtained toner particles were washed using a filtration device until the electrical conductivity of the washing water became 0.5 μS/cm, and then dried using a vacuum dryer until the water content became 0.3 wt %. The thus obtained toner particles had a volume average particle diameter of 4.9 μm and a CV value representing the distribution of 20%. Further, the resulting toner had a BET specific surface area of 7.7 m²/g, a surface acid value of 2.7894 mgKOH/g, and an SAV of 0.3623 mgKOH/m². The charge amount under low temperature and low humidity was 43.0 μC/g, the charge amount under high temperature and high humidity was 9.3 μC/g, and the environmental coefficient of variation was 20%.

### Comparative Example 4

100 parts by mass of the dispersion liquid 1 (solid content concentration: 40%) and 100 parts by mass of deionized water were placed in a glass-made separable flask equipped with a stirrer. As an aggregating agent, an aqueous solution of hydrochloric acid was continuously added dropwise thereto using a pump while rotating a paddle-type stirring blade at 700 rpm and keeping the internal temperature of the flask at 30° C. Hydrochloric acid was added in an amount of 0.30 parts by mass based on the toner solid content. Subsequently, the temperature was raised to 85° C. over 3 hours, and then kept at 85° C. for 4 hours, thereby fusing the toner particles. After cooling, the obtained toner particles were washed using a filtration device until the electrical conductivity of the washing water became 0.5 μS/cm, and then dried using a vacuum dryer until the water content became 0.3 wt %. The thus obtained toner particles had a volume average particle diameter of 4.8 μm and a CV value representing the distribution of 20%. Further, the resulting toner had a BET specific surface area of 2.1 m²/g, a surface acid value of 0.7840 mgKOH/g, and an SAV of 0.3740 mgKOH/m². The charge amount under low temperature and low humidity was 71.3 μC/g, the charge amount under high temperature and high humidity was 11.7 μC/g, and the environmental coefficient of variation was 16%.

As described above, it can be understood that each of the toners of Examples, which had an acid value per unit surface area SAV (mgKOH/m²) of 0.05 or more but not exceeding 0.2, had an environmental coefficient of variation of more than 25%, and therefore had a stable charging property.

Further, a developer (carrier: ferrite core having a particle diameter of 40 μm) containing each of the toners of Examples and Comparative examples was prepared and placed in a copier e-Studio 4520c manufactured by Toshiba Tec Corporation, and a patch image was formed using the developer. As a result, a favorable image could be obtained in the case of the developer containing each of the toners of Examples, and particularly in the case of the developer containing each of the toners of Examples 1 and 2, a sufficient image density was obtained without causing fogging or the like.

On the other hand, in the case of the developer containing each of the toners of Comparative examples, image defects such as fogging or insufficient image densities were caused.

While certain embodiments have been described, these embodiments have been presented by way of example only, and are not intended to limit the scope of invention. Indeed, the novel method described herein may be embodied in a variety of other forms; furthermore, various omissions, substitutions and changes in the form of the compound described herein may be made without departing from the spirit of the inventions. The accompanying claims and their equivalents are intended to cover such forms or modifications as would fall within the scope and spirit of the inventions.

As described in detail above, according to the technique described herein, a toner having a stable charging property can be provided even if the toner has a volume average particle diameter of 7 μm or less.

What is claimed is:

1. An electrophotographic toner, comprising a binder resin, a coloring agent, and a release agent, wherein the toner has a volume average particle diameter of 7 μm or less and has an acid value per unit surface area SAV (mgKOH/m²) of 0.05 or more but not exceeding 0.2.

2. The toner according to claim 1, wherein the toner is produced by aggregating and fusing the binder resin, the coloring agent, and the release agent in an aqueous medium.

3. The toner according to claim 2, wherein the binder resin, the coloring agent, and the release agent are aggregated in an aqueous medium at 20° C. or higher but not exceeding the glass transition temperature of the resin, and fused at the glass transition temperature of the resin or higher but not exceeding 100° C.

4. The toner according to claim 3, wherein the binder resin, the coloring agent, and the release agent are aggregated using an aggregating agent which is hydrochloric acid, sulfuric acid, nitric acid, phosphoric acid, acetic acid, acetic anhydride, citric acid, or a mixture of at least two or more compounds selected therefrom.

5. The toner according to claim 1, wherein the toner has an acid value per unit surface area SAV (mgKOH/m²) of 0.09 or more but not exceeding 0.16.
